(19) United States
(12) Patent Application Publication
(10) Pub. No.: US 2011/0236550 A1
(43) Pub. Date: Sep. 29, 2011

(54) STABILIZATION OF PHENOLIC ANTIOXIDANTS IN FAT-CONTAINING FOODS

(76) Inventor: Daniel Perlman, Arlington, MA (US)

(21) Appl. No.: 12/372,773

(22) Filed: Feb. 18, 2009

(51) Int. Cl. C11B 5/00

(52) U.S. Cl. 426/546

(57) ABSTRACT

A fat-containing processed food composition is described that is suitable for human consumption, and that contains exogenously added microparticles of phenolic antioxidants dispersed but not dissolved in an antioxidant-protective edible oil/fat portion of the food composition. The oxidative stability of the phenolic antioxidants in the fat or oil portion of the food composition is substantially greater than when dissolved in an equal portion of water at pH 7.

### RELATED APPLICATIONS

Analytical methods, definitions of technical terms, and background for the present application are described in co-pending U.S. Pat. Appl. Publ. 20080044539 (application Ser. No. 11/743,788) filed May 3, 2007, which is incorporated herein by reference in its entirety.

### FIELD OF THE INVENTION

The present invention relates to fortification of foods with biologically active phenolic antioxidants such as the proanthocyanidins and catechins that are water-soluble and normally dissolved in water-based food products, and the protection of the phenolic antioxidant from premature oxidation using fats or oils.

### BACKGROUND OF THE INVENTION

The following discussion is provided solely to assist the understanding of the reader, and does not constitute an admission that any of the information discussed or references cited constitute prior art to the present invention.

Oxidative or hydrolytic breakdown of certain nutrients contained in processed food products, is a significant problem faced by formulators of processed foods throughout the world. Some nutrients and micronutrients that lack oxidative and/or hydrolytic stability (collectively termed “unstable nutrients”) exist in processed foods as endogenous constituents, while others are exogenously added to improve the nutritional profile of the food.

A variety of strategies have been employed to stabilize both endogenous and exogenously added unstable biofunctional nutrients present in processed foods. For example, flax seed oil-containing omega-3 fatty acids that are prone to rancidity can be stabilized by substantial dilution of the alpha-linolenic acid (ALA)-containing triglyceride molecules into an oleic acid-rich vegetable oil such as that provided within high oleic peanut butter as described by Perlman in U.S. Pat. No. 7,344,747. On the other hand, sacrificial antioxidant agents including natural alpha-tocopherol (vitamin E), or synthetic TBHQ, BHA, BHT and propyl gallate can also be added to foods to protect a variety of unstable nutrients that are susceptible to oxidation. While these particular agents are fat-soluble and useful for protecting polyunsaturated fatty acids and natural colors and flavors against oxidation, there are other sacrificial antioxidants that are water-soluble and useful for protecting unstable nutrients in the aqueous portion of processed foods. Examples of the latter include vitamin C (ascorbic acid) and glutathione (with a cysteine thiol group). Interestingly, if multiple antioxidants are present in the fat or the water portion of a processed food, the most readily oxidized antioxidant tends to be sacrificed first, protecting the other antioxidants from degradation. For example, when water-soluble vitamin C is added to grape juice as a sacrificial antioxidant, it can protect the bio-functional proanthocyanidin phenolic antioxidants in the juice. Similarly, the fat-soluble synthetic antioxidant, TBHQ, typically functions as a sacrificial antioxidant in a vegetable oil to protect carotenoid antioxidants such as lutein or lycopene if they are also present.

Acidic solution conditions have been utilized to stabilize phenolic compounds in food products, for example, as described in a number of patent applications from Unilever Corporation. For example, in Graff & Hrncirik, WO 2007/048471, an aqueous fluid wine extract was added to a variety of food products, including fruit juice products (p. 9), dairy products (p. 10), frozen confectionary products (p. 10), nutrition bars (p. 11), and food emulsions/spreads (p. 12-13). Particularly, in connection with the spreads, the inventors indicated that a pH of 4.2-6.0 was advantageous (p. 13, line 4). Similarly in a set of four US patent application filed by Unilever on the same day and all entitled Composition Comprising Polyphenol, single phenolic compounds were used in food products substantially the same as those indicated above. The application publications are: Draijer et al., US Pat Appl Publ 20090011103 (coumaric acid); Draijer et al., US Pat Appl Publ 20090012183 (trans-resveratrol); Draijer et al., US Pat Appl Publ 20090010993 (kaempferol); and Draijer et al., US Pat Appl Publ 20090012156 (isorhamnetin). Reference to the advantageous pH of 4.2-6.0 (the same as in WO 2007/048471) was made in each application in paragraphs 41, 38, 43, and 37 respectively. These mildly acidic pH's assist in stabilizing the polyphenol. Acidic stabilization of phenolic antioxidants in aqueous suspension was also utilized in Zhang, US Pat Appl Publ 20090017183 (assigned to the same company, Unilever, as the Graff and Draijer applications mentioned above) in which a plant-derived acid such as gallic acid or p-coumaric acid (among others) was used to stabize tea catechins, and was said to produce a better tasting beverage than when citric acid was used as an acid stabilizer. The pH of the resulting beverage solution was preferably in the range of 2.5 to about 6.0 (paragraph 34).

It is probable that formulators of processed food products would look to water-based foods and beverages to solubilize phenolic antioxidants rather than vegetable oils that fail to dissolve these antioxidants. For example, use of a vegetable oil vehicle may be a problem because phenolic antioxidant solids tend to settle out of the oil due to their greater density. Insoluble antioxidant particles in oil may also contribute a gritty texture. Indeed, the consumer looks to wine, tea, fresh fruit beverages, tomato juice and vegetable-based juices as sources of soluble phenolic antioxidants.

While there are many different bioactive phenolic antioxidants, many health benefits have been attributed to the dietary consumption of one group of water-soluble phenolic antioxidants known as the proanthocyanidins. A partial list of health conditions that have been reported to benefit from regular ingestion of proanthocyanidins are as follows: heart disease and atherosclerosis, pancreatic inflammation, cancer cell proliferation, kidney, lung and heart cell damage (e.g., damage caused by chemotherapeutic drug treatments). Related phenolic antioxidants have been shown to beneficially modulate or control blood platelet aggregation, LDL oxidation, endothelial dysfunction, rheumatoid arthritis and leukemia cell propagation. A bibliography that encompasses much of the recent research (years 2000-2005) involving phenolic antioxidants and their role in controlling disease is provided in the book, Muscadine Medicine by Hartle, Greenspan and Hargrove (2005) ISBN Number 1-4116-4397-6. More specifically, with regard to the health benefits provided by proanthocyanidins in the diet, several informative review articles are available at, for example, http://www.blackwell-synergy.com/doi/gdf/10.1111/j.1469-8137.2004.01217.x and at http://repositories.cdlib.org/cgi/viewcontent.cgi?article=1045&context=uclabiolchem/nutritionnoteworthy

The antioxidants present in grapes, for example, have received a great deal of attention in recent years. For example:
1) O'Byrne et al. Am J Clin Nutr (2002) 76(6):1367-1374 compare two groups of healthy adults consuming either vitamin E (400 IU RRR-alpha-tocopherol) per day or 10 ml Concord grape juice (CGJ) per kg body weight per day for two weeks. Whereas the serum ORAC value (Oxygen Radical Absorbance Capacity) and the resistance of plasma LDL cholesterol to oxidation were increased to comparable extents by both treatments, CGJ was significantly more effective than vitamin E in protecting plasma proteins against oxidation.
2) Frankel et al. J Agric Food Chem (1998) 46:834-838 and Ghiselli et al. J Agric Food Chem (1998) 46:361-367 have shown that the anthocyanin phenolic antioxidants in Concord grape juice and red wine strongly retard LDL lipid peroxidation.
3) Freedman et al. Circulation (2001) 103(23):2792-2798 describes blood platelets incubated with dilute purple grape juice (PGJ). This led to beneficial inhibition of platelet aggregation, enhanced platelet-derived nitric oxide release and decreased oxidative activity (superoxide production). This was confirmed in vivo with healthy human subjects consuming 7 ml PGJ per kg body weight per day for 2 weeks, as platelet aggregation was inhibited, platelet-derived nitric oxide production nearly doubled, superoxide production decreased by about ⅓, plasma vitamin E levels increased and plasma antioxidant status improved.
4) Osman et al. J. Nutr. (1998) 128(12):2307-2312 describes the role of platelet aggregation in contributing to atherosclerosis and acute thrombosis formation. Gastric administration of 5-10 ml purple grape juice per kg body weight was capable of reducing platelet aggregation in both dogs and monkeys, whereas neither orange juice nor grapefruit juice showed such activity. The authors concluded that grape juice is very effective because it contains high levels of the flavonoids-quercetin, kaempferol and myricetin that are known to be effective inhibitors of platelet aggregation in vitro, whereas the citrus juices contain other flavonoids that are poor inhibitors of platelet aggregation.
5) Ko et al. J Med Food (2005) 8(1):41-46 evaluated the antioxidant status in human plasma for up to 2 hours following consumption of 150 ml of nine different fruit juices by healthy adult males, using the method of measuring dichlorofluorescein fluorescence whose intensity indicates the level of reactive oxygen species in the plasma. Grape juice was the only juice to exert a persistent antioxidant activity that depressed the fluorescent intensity for over two hours following ingestion.
6) Ariga Biofactors (2004) 21(1-4):197-201 describes the proanthocyanidin antioxidants found in grape seed extracts. These compounds were found to be substantially more active than either vitamin C or vitamin E in aqueous systems, and were shown to slow the progression of a number of diseases in animal models. In a separately published USDA database (www.nal.usda.gov/fnic/foodcomp/Data/PA/PA.html), it has been reported that among a large number of juices and beverages tested, Concord purple grape juice contained the highest concentration of the proanthocyanidins (124 mg per 8 oz serving).
7) Shi et al. J Med Food (2003) 6(4):291-299 describe grape seed waste from production of grape juice in which the seed contains 5-8% phenols, mainly flavonoids, including gallic acid, the monomer flavanols catechin, epicatechin, gallocatechin, epigallocatechin, epicatechin 3-O-gallate, and procyanidin dimers, trimers and higher polymers. The antioxidant power of the grape seed phenolic proanthocyanidins is claimed to be 20 times greater than vitamin E and 50 times greater than vitamin C.

A limited amount of endogenous phenolic antioxidants is commonly found naturally in olive oil, with the highest levels indicated for extra virgin olive oil. In most cases it appears that the level is only about 0.01 to 0.04% by weight, although levels approaching 0.08% have been reported for certain preparations. It is likely that at least some of the phenolic antioxidants in olive oil are essentially insoluble in the oil and thus might be in microparticulate form in the colloidal particle size range (due to the absence of settling of such particles in olive oil products).

Throughout the world, fruits and vegetables that provide a diverse set of beneficial water-soluble phenolic antioxidants have become a nearly universal part of the human diet for growing children as well as adults. While the U.S. FDA has not yet approved a “qualified health claim” to be made for the dietary consumption of phenolic antioxidants extracted from fruits and vegetables, there is strong clinical evidence that consuming such antioxidants is beneficial to ones health. Some of the health conditions that have been reportedly improved by phenolic antioxidants contained in fruits and vegetables include decreased platelet aggregation, improvements involving a wide range of inflammatory diseases including rheumatoid arthritis, and beneficially reducing the amount of LDL cholesterol oxidation that occurs in the bloodstream, and that may contribute to atherogenesis.

While a maximum safe level of phenolic antioxidants has not been established, it is believed that daily intake of at least 1-5 grams of the phenolics is not excessive. While such levels may be desirable goals for many health-conscious individuals, it is believed that making even a fraction of these levels available to the general public by supplementing conventional foods will result in a significant public health benefit.

### SUMMARY OF THE INVENTION

The present invention concerns the supplementation of fat-based processed food compositions with plant matter-derived (e.g., fruit or vegetable-derived) phenolic antioxidants, in which fat is surprisingly functional for protecting these phenolics from oxidation. Omega-3 fatty acids such as DHA and EPA may be optionally added, but are not protected from oxidation by these water-soluble phenolics. Instead, when added, the omega-3 fatty acids can be protected by dilution into a high oleic, low linoleic acid stabilizing oil as previously described by Perlman in U.S. Pat. No. 7,344,747 and in Perlman, U.S. Pat Appl 12/143,729, filed Jun. 20, 2008 and/or Perlman U.S. Pat Appl 12/276,447, filed Nov. 24, 2008, each of which is incorporated herein by reference in its entirety. Among other human health benefits, the phenolic antioxidants and omega-3 fatty acids both exhibit anti-inflammatory properties and support heart and circulatory health. While the phenolic antioxidants including the proanthocyanidins, catechins and other phenolic compounds are very soluble in water, they exhibit very little solubility in a vegetable oil or fat. The opposite is true for omega-3 fatty acids that are provided in nature in the form of triglyceride-based edible oils. Therefore, the use of triglycerides in food as a vehicle for phenolic antioxidants is counterintuitive, as is the combining of bioactive phenolic antioxidants and omega-3 fatty acids in fats.

Thus, a first aspect of the invention concerns a fat-containing processed food composition suitable for human consumption which includes at least one Antioxidant-Protective triglyceride-based fat or oil component (herein abbreviated “AP fat component”) that may or may not contain a water portion. Thus, the AP fat component and the food-composition include a fat portion and optionally an aqueous portion. The AP fat component also includes at least one chemical species of exogenously added water-soluble phenolic antioxidant that is dispersed yet substantially undissolved within the fat portion of the food composition. Highly preferably, the AP fat component is diffusion-inhibiting or includes a diffusion-inhibiting component. Also highly preferably, the oxidative stability of the phenolic antioxidant in the fat portion is greater than when dissolved in an equal portion of water at pH 7. The terms “fat” and “oil” as used herein are used interchangeably and meant to each include triglycerides that are either liquid, solid or semi-solid at room temperature.

In certain embodiments, the exogenously added phenolic antioxidant is derived from at least one plant; the exogenously added phenolic antioxidant is purified to a preparation comprising at least 30, 40, 50, 60, 70, 80, or 90% by weight phenolic antioxidants; the exogenously added phenolic antioxidant is in the form or predominantly in the form of non-colloidal microparticles, e.g., with a median diameter of about 1 to 10, 1 to 20, 1 to 30, 1 to 40, 1 to 50, 1 to 100, 1 to 150, 1 to 180, 1 to 200, 10 to 40, 10 to 70, 10 to 100, 10 to 150, 10 to 180, 10 to 200, 20 to 50, 20 to 70, 20 to 100, 20 to 150, 20 to 180, 20 to 200, 50 to 100, 50 to 150, 50 to 180, or 50 to 200 micrometers, or will pass through an 80, 100, 120, 140, 170, 200, 230, 270, or 325 mesh or is in a size range defined by taking any two of the listed median diameters or mesh sizes as upper and lower size limits respectively (e.g., where the particles will pass through a mesh of the two mesh sizes having the larger openings and will not pass through a mesh of the mesh size having the smaller openings); the microparticles include 5 to 100, 5 to 95, 5 to 90, 5 to 70, 5 to 50, 5 to 30, 5 to 20, 7 to 100, 7 to 95, 7 to 90, 7 to 70, 7 to 50, 7 to 30, 7 to 20, 10 to 100, 10 to 90, 10 to 70, 10 to 50, 10 to 30, 50 to 100, 50 to 90, 50 to 70% by weight of the phenolic antioxidants. In other embodiment, the exogenously added phenolic antioxidant is in the form or predominantly in the form of colloidal particles, e.g., with a median diameter of at least 1 nanometer (nm) but less than 1 micrometer, at least 10 nm but less than 1 micrometer, 1 to 500 nm, 1 to 200 nm, 1 to 100 nm, at least 50 nm but less than 1 micrometer, 50 to 500 nm, 50 to 200 nm, at least 100 nm but less than 1 micrometer, 100 to 500 nm, at least 300 nm but less than 1 micrometer, 300 to 800 nm, 300 to 600 nm, or at least 500 nm but less than 1 micrometer.

In some embodiments, the colloidal and/or non-colloidal microparticles are or include purified phenolic antioxidants, such as a water-soluble powdered extract selected from the group consisting of grape seed extract and Camellia sinensis extract; the colloidal and/or non-colloidal microparticles are or include plant matter flour; the colloidal and/or non-colloidal microparticles are selected from the group consisting of fruit seed flour microparticles (e.g., grape seed, raspberry seed, blueberry seed, pomegranate seed), fruit skin flour microparticles, and plant leaf flour (e.g., Camellia sinensis flour) particles, and combinations thereof (e.g., Camilla sinensis flour and grape seed flour).

For particular embodiments, the diffusion-inhibiting oil component is substantially free of water as an external phase; the diffusion-inhibiting oil component is a water-in-oil emulsion; the diffusion-inhibiting oil component includes oil droplets in an aqueous carrier, e.g., as an oil-in-water emulsion.

In some embodiments, the phenolic antioxidant is trapped within a matrix, e.g., provided by solid or semi-solid fat or oil, and/or by a fiber network such as a fiber network particle. Such fiber network can, for example, be or include plant matter particles, e.g., particles of plant matter flour such as those indicated above.

In particular embodiments, the food composition is a solid vegetable shortening, a liquid vegetable shortening, a liquid vegetable cooking oil, a sweetened bakery shortening, a margarine spread (e.g., a margarine emulsion-type spread whose external phase is substantially triglyceride-based and whose internal phase is substantially aqueous-based), a reduced fat spread, a processed cheese, a cream cheese, a peanut butter, a liquid milk, or a yogurt.

Also in certain embodiments, the total level of phenolic antioxidants in the fat portion, or alternatively the level of exogenously added phenolic antioxidants in the fat portion is from 0.10 to 2.00%, 0.10 to 1.50%, 0.10 to 1.00%, 0.20 to 2.00%, 0.20 to 1.50%, 0.20 to 1.00%, 0.50 to 2.00%, 0.50 to 1.50%, 0.50 to 1.00%, 2.00 to 3.00%, 2.00 to 4.00%, 2.00 to 5.00%, 2.00 to 6.00%, or 4.00 to 6.00% by weight of the fat portion; the exogenously added phenolic antioxidant level in the fat portion is at least 0.05% with the endogenous phenolic antioxidant level less than 0.10% and the total phenolic antioxidant level at least 0.10% by weight; the exogenously added phenolic antioxidant level in the fat portion is at least 0.20% with the endogenous phenolic antioxidant level less than about 0.10% and the total phenolic antioxidant level at least 0.20%; the exogenously added phenolic antioxidant level in the fat portion is at least 0.50% with the endogenous phenolic antioxidant level less than about 0.10% and the total phenolic antioxidant level at least 0.5%; the exogenously added phenolic antioxidant level in the fat portion is at least 1.00% with the endogenous phenolic antioxidant level less than about 0.10% and the total phenolic antioxidant level at least 1.00%, the exogenously added phenolic antioxidant level in the fat portion is at least 2.00% with the endogenous phenolic antioxidant level less than about 0.10% and the total phenolic antioxidant level at least 2.00%.

In certain embodiments, a plurality of different exogenous phenolic antioxidants are added, e.g., at least 2, 3, 4, 5, 6, 7, 8, 9, 10, or more different molecular species; a plurality of exogenously added phenolic antioxidants includes both glycosylated and aglycone phenolic antioxidants, preferably with a diversity of chemical species as just indicated; a balanced plurality of N different exogenous phenolic antioxidants is added, where each of the N different chemical species of antioxidants in the balanced plurality constitutes a fraction of the total phenolic antioxidants in that balanced plurality within the range (1/N±(B×1/N) with B equal to 0.1, 0.2, 0.3, 0.4, 0.5, 0.6, or 0.7.

For some embodiments, the fat component is substantially free of water as an external phase and the food composition includes at least 10, 15, 20, 30, 40, 50, 70, or 90% by weight of the antioxidant-protective (e.g., diffusion-inhibiting) fat component, or the fat portion constitutes the just specified percentage of the food composition, in some cases including from 0.10% to 2.00% by weight of exogenously added phenolic antioxidants or other level of phenolic antioxidants as specified for embodiments above; the fat component or the fat portion of the food composition constitutes from 10 to 99, 10 to 90, 10 to 80, 10 to 50, 10 to 30, 30 to 99, 30 to 90, 30 to 80, 30 to 50, 50 to 99, 50 to 90, 50 to 80, or 50 to 70% by weight of the food composition.

For some embodiments, water is present sequestered within a water-in-oil emulsion, or is otherwise segregated from the fat or oil portion; in some cases water is likewise sequestered or segregated and constitutes from 10 to 99%, 10 to 80%, 10 to 50%, or 10 to 30% by weight of the food composition.

In certain advantageous embodiments, the oxidative stability at 21 degrees C. of the at least one chemical species of phenolic antioxidant suspended in the fat portion is at least two-fold, three-fold, four-fold, five-fold, seven-fold, or ten-fold greater than when dissolved in an equal portion of water at pH 7.

For advantageous embodiments, any taste astringency resulting from the presence of the at least one chemical species of phenolic antioxidant suspended within the fat portion is substantially less than the taste astringency resulting from the same amount of the at least one chemical species of phenolic antioxidant dissolved in an equal portion by weight of water.

In yet further embodiments, the fat portion includes at least one triglyceride-based omega-3 fatty acid-enriching oil combined within the fat portion of the composition, e.g., fish oil, algae oil, flax seed oil, or a combination thereof. In some cases of such embodiments, the omega-3 fatty acid-enriching oil or the omega-3 fatty acids in the enriching oil is DHA, EPA, ALA, or any combination of two or more of the specified items. In some embodiments, the fat portion of the food composition also contains at least one fat-soluble antioxidant, e.g., one or more carotenoids such as lycopene, lutein, gamma-carotene, astaxanthin, canthaxanthin, alpha-carotene, bixin, zeaxanthin, cryptoxanthin, and crocin, and/or well as fat-soluble vitamins such as Vitamin E, Vitamin A (or the related beta-carotene), Vitamin D, and/or Vitamin K.

A related aspect of the invention concerns a method of producing a shelf-stable processed food product which is or includes a food composition containing at least one chemical species of exogenously added phenolic antioxidant (often plant matter-derived phenolic antioxidants). The method involves incorporating at least one exogenously added chemical species of phenolic antioxidant (e.g., plant matter-derived phenolic antioxidant) into the fat portion of a food composition having an AP fat component (e.g., a diffusion-inhibiting oil component), and incorporating that fat component into the food product. Highly preferably the phenolic antioxidant is stabilized against oxidation by its incorporation into the fat portion. Also highly preferably the phenolic antioxidants are added as a mixture (or to produce a mixture) of different chemical species, e.g., with at least 2, 3, 4, 5, 7, 10 or more chemical species being present at significant levels in the mixture). Alternatively and/or in addition, the phenolic antioxidants may be dispersed in microparticles of a digestible solid material (e.g., solid fat or wax), which may optionally be suspended in an oil, e.g., a liquid oil.

In particular embodiments, the food product or food composition, AP fat component (e.g., diffusion-inhibiting oil component), fat portion, digestible solid material, phenolic antioxidant, microparticles, omega-3 fatty acid addition, and/or property(ies) of such a composition are as described for the preceding aspect or an embodiment thereof, or otherwise described herein for the present invention.

Another related aspect concerns a method of stabilizing water soluble phenolic antioxidants (often plant matter-derived phenolic antioxidants) against oxidation by suspending colloidal and/or non-colloidal microparticles of the phenolic antioxidants (e.g., an antioxidant extract or microparticles containing the phenolic antioxidants) within a fat composition (which may be a fat portion of a food composition). The fat composition is or includes an AP fat component, which may, for example, be a diffusion-inhibiting oil component, such as oil-saturated fiber matrix particles such as oil-saturated plant matter flour or microparticles of a digestible solid material, such as a solid fat or wax.

In particular embodiments, the AP fat component (e.g., the diffusion-inhibiting oil component), fat portion, digestible solid material, phenolic antioxidant, microparticles, omega-3 fatty acid addition, and/or property(ies) of such a composition are as described for an aspect above or an embodiment thereof, or otherwise described herein for the present invention, or the diffusion-inhibiting oil composition is incorporated in a food composition as specified for an aspect above or otherwise indicated herein for the present invention.

Additional embodiments will be apparent from the Detailed Description and from the claims.

### DETAILED DESCRIPTION OF THE PREFERRED EMBODIMENTS

### I. Introduction

In recent years, the medical community has become increasingly aware of the importance of consuming phenolic antioxidants as a regular part of the human diet. The further consumption of omega-3 fatty acids supplied by fish oil, algae oil, and/or flaxseed oil is also recognized as important. However, a difficulty with such additions to processed foods has been that the phenolic antioxidants can relatively rapidly oxidize at room temperature in typical aqueous foods near neutral pH and lose biological efficacy, while the fish oils or other omega-3 fatty acid-containing oils may take on a fishy odor and flavor.

The present invention concerns the stabilization of phenolic antioxidants in processed foods, optionally together with omega-3 fatty acids, e.g., in the form of flax seed oil providing alpha-linolenic acid (ALA), or fish oil (providing EPA and DHA) or algae oil (providing DHA). In fact, the process of oxidative and hydrolytic breakdown of both phenolic antioxidants and omega-3 fatty acids involves many variables, and the factors that affect the rates of these processes in aqueous, oil and emulsion food components are numerous and interdependent. Consequently, there is often no substitute for experimentation and empirical observation to find conditions for reducing or preventing degradation of these food ingredients.

In the present invention, Applicant has shown that: (a) fat can be used to coat and protect microparticles of phenolic antioxidants or microparticles containing such phenolic antioxidants from water and air, thereby stabilizing the antioxidants against premature hydrolysis and oxidation, and (b) phenolic antioxidants and omega-3 fatty acids are chemically compatible, stable and non-reactive, and therefore can be combined in a fatty food environment. The phenolic antioxidant stabilization by fat involves protection of the phenolic antioxidant from a reactive environment, especially an aqueous environment. In general this can be accomplished by placing the phenolic antioxidants in an environment such that contact of those antioxidants with water or similar reactive environment is at least substantially slowed. For example, when suspended in an oil, water is substantially absent. Microparticles of phenolic antioxidants will encounter air at the oil-air interface, but slow diffusion in a relatively viscous oil results in the oil providing substantial protection for the antioxidant. Likewise, microparticles of phenolic antioxidants can be suspended in the oil phase of an oil-water emulsion in which the oil is the external phase (such as margarine). The fat-coated phenolic antioxidants are protected from the aqueous droplets in the emulsion and thus stabilized.

This protective effect is increased when the emulsion (and especially the oil phase) is solidified, trapping the antioxidants within a matrix formed by the solidified or semi-solidified oil, at least in part because transfer of the phenolic antioxidants to a position where diffusion into an aqueous phase can occur is very significantly further reduced. Trapping the phenolic antioxidants within a matrix which inhibits transfer of the antioxidants from the oil to an aqueous environment can also be accomplished by other types of matrices. These other types of matrices can include, for example, small fiber or fiber-rich particles. An example of such fiber matrices is finely ground grape seed flour (or other fibrous plant material flours), which is discussed further below. Such fiber matrices can also include a large number of other natural product or synthetic fiber matrices.

It was additionally found that by preventing solubilization of these antioxidants, fatty foods have been found to significantly reduce undesirable phenolic astringency that is otherwise tasted in an aqueous food or beverage when the phenolic antioxidants are present at substantial levels.

Further, by choosing a suitably inert fat carrier (preferably a monounsaturated or saturated fat) for the phenolic antioxidant, that fat can be simultaneously used to stabilize polyunsaturated omega-3 fatty acids against premature oxidation as described by Perlman in U.S. Pat. No. 7,344,747 and/or in Perlman, U.S. patent application Ser. No. 12/143,729, filed Jun. 20, 2008 and/or Perlman U.S. patent application Ser. No. 12/276,447, filed Nov. 24, 2008, each of which is incorporated herein by reference in its entirety. The omega-3 fatty acids can, for example, be provided by an omega-3 enriching oil such as algae oil (providing DHA) or fish oil (providing EPA and DHA) or flax seed oil (ALA).

### II. Phenolic Antioxidant Stabilization in Fats and Oils

The present invention describes a fat-containing processed food composition for human consumption in which microparticulate phenolic antioxidants are dispersed but not dissolved in the fat portion of the processed food, e.g., in a diffusion-inhibiting oil component. Inclusion of the phenolic antioxidants in this way can significantly reduce exposure of those antioxidants to aqueous phase portions of the food. In advantageous cases, the oil portion of the food composition will have about 0.10 to 2.00% by weight or even more of the phenolic antioxidants, typically vegetable and/or fruit derived phenolic antioxidants.

For many food compositions, the food composition will contain at least 10% by weight of at least one triglyceride-based fat or oil that is used as a carrier for between 0.01% and 0.20% by weight of at least one vegetable or fruit-derived phenolic antioxidant compound (as a percentage of the food composition). The fat portion of the food composition contains at least one phenolic antioxidant molecular species or compound as a solid but finely divided or microparticulate material that is dispersed but not dissolved in the fat portion of the composition. Generally, the oxidative stability of phenolic compounds, when present in a solid state microparticle surrounded by fat, is substantially greater than if the phenolic compound is dissolved in an aqueous processed food component having an approximately neutral or slightly alkaline pH.

The general population benefits from regularly consuming more fruit and vegetables rich in phenolic antioxidants, and processed foods fortified with phenolic antioxidants that are part of a healthy diet. Phenolic antioxidant molecular diversity and broader health functionality can be provided by dietary consumption of a variety of sources of phenolic antioxidants. In principle, such diversity can permit multiple health conditions to be treated with regular dietary intake of diverse phenolic antioxidants rather than a single antioxidant compound. Such inclusion of a diversity of phenolic antioxidants is in contrast to the single compound specified in the Draijer et al. applications mentioned in the Background. An increase of 25%, 50%, and preferably 100% or more in phenolic antioxidant content over the endogenous level present in a processed food via admixture of exogenous antioxidants can be achieved for a minimal cost, i.e., approximately 0.1-1 cent per serving.

In recent years, the scientific literature has suggested that different species of phenolic (commonly polyphenolic) molecules can exhibit different biochemical properties and provide a range of health benefits when consumed regularly in the human diet. Thus, it is believed that a combining of phenolic antioxidants, e.g., from grape seeds and teas for example, may provide greater health benefits than from either individually. It is contemplated that in some instances, the antioxidants from tea and grape seed be combined, e.g., in approximately equal proportions based upon their phenolic antioxidant activities as measured in ORAC or GAE units.

A diversity and balance between glycosylated and aglycone phenols may also be desirable. For example, with acai berries, Del Pozo-lnsfran et al., J. Agric. Chem. (2006) 54(4):1222-1229 demonstrated that the glycosylated forms of polyphenolic acids and flavanols were more potent in affecting leukemia cell proliferation and cell death in culture than aglycone forms. Thus, in some cases the present invention incorporates both glycosylated and aglycone phenols (e.g., in a balanced combination), preferably with a diversity of chemical species as discussed above.

The biological functionality of these phenolic antioxidants as anti-inflammatory agents and agents to reduce both harmful oxidation of LDL cholesterol and platelet aggregation in the bloodstream, can be enhanced by the further addition of a triglyceride-based omega-3 fatty acid enriching oil to provide DHA, EPA and ALA, for example. That is, phenolic antioxidants and omega-3s can provide complementary and potentially synergistic health benefits if combined together and oxidatively co-stabilized in fat-based foods as described herein. This is supported by earlier suggestions of benefits from consuming both phenolic antioxidants and omega-3 fatty acids in ones diet evident in the scientific literature (e.g., as illustrated by results of a web search at <www.ncbi.nlm.nih.gov/sites/entrez> using the search terms, “omega-3” and “polyphenols”). This search suggests use of both these agents in the diet to modulate or control lipoprotein levels, oxidative damage, inflammation, Alzheimer's disease, cancers, inflammatory bowel disease, and cardiovascular disease. A similar search at the same web address using the search terms “grape seed” and “inflammatory” provided additional references. While oxidative decomposition and modes of oxidative stabilization differ for phenolic antioxidants and omega-3 fatty acids, both agents are beneficial to ones health and can be compatibly combined in the fat portion of processed foods as described herein and in U.S. Pat. No. 7,344,747.

With regard to the separate health benefits of omega-3 fatty acids, the U.S. FDA has given “qualified health claim” status to eicosapentaenoic acid (EPA) and docosahexaenoic acid (DHA) omega-3 fatty acids for reducing the risk of coronary heart disease (CHD). Concerning additional major benefits provided by omega-3s, fish oil appears to stimulate circulation, promotes fibrin/blood clot breakdown, and decreases blood pressure in some individuals, along with generally decreasing blood triglyceride levels, a risk factor in CHD and heart attacks. EPA can also significant decrease/improve the thickness of carotid arteries along with improvement in blood flow. Moderate levels of EPA and DHA (typically 1-4 g per day) also tend to help reduce cardiac arrhythmias, the incidence of ischemic and thrombotic stroke, as well as the effects of arthritis. Preliminary evidence suggests that EPA and DHA may reduce psychological depression, anxiety aggression and attention-deficit hyperactivity disorder. Several studies also report possible anti-cancer effects of omega-3 fatty acids (breast, colon and prostate cancer).

Still another study with fish oil published in 2007 showed that infants receiving either cow's milk or infant formula supplemented with fish oil showed healthy immune system activation with improved immune function maturation. Research in 2005 and 2006 has suggested that in-vitro anti-inflammatory activity of omega-3 fatty acids translates into clinical benefits. For example, neck pain patients and rheumatoid arthritis sufferers have demonstrated benefits comparable to those receiving standard non-steroidal anti-inflammatory drugs. Other diseases for which amelioration has been reported with the regular consumption of EPA and DHA include Alzheimer's disease, Parkinson's disease, and atopic dermatitis.

While the dietary consumption of natural phenolic antioxidants extracted from fruits and vegetables may provide multiple health benefits, the addition of phenolic antioxidants to commercially processed foods has been limited for a variety of reasons. In addition to the cost of these antioxidant ingredients, their susceptibility to premature oxidation, their astringent taste, and their deep color tend to complicate the use of phenolic antioxidants in many processed foods. Furthermore, their stability in an acidic food environment, but not in a neutral or alkaline pH environment has tended to limit the foods that can be supplemented. The present invention facilitates the addition of phenolic antioxidants to certain types of processed foods, i.e., fat-containing foods, as well as improving the stability and shelf life of phenolic antioxidants in foods.

Phenolic antioxidants as described herein are typically water-soluble chemical compounds, many of which are stable at low pH, allowing their incorporation into acidic food products. Thus, fruit juices, fruit sauces, and other fruit products, as well as tomato-based products, fermented dairy products (e.g., yogurt), and vinegar-containing products (e.g., sauerkraut, soy sauce, mustard, salad dressing) can provide a sufficiently acidic environment for stabilizing phenolic antioxidants. More specifically, these foods typically contain one or more organic acids, e.g., tartaric, maleic, succinic, quinic, citric, acetic and lactic acids that can, at least, partially stabilize phenolic antioxidants and extend the shelf life of the food. In some instances, a sacrificial antioxidant that is more susceptible to oxidation than the phenolic antioxidant is also added (e.g., vitamin C added to grape juice). Such stabilization utilizing an acidic aqueous environment is described, for example, in the Graff & Hrncirik, Draijer et al., and Zhang applications discussed briefly in the Background, each of which is incorporated herein by reference in its entirety.

In the absence of an acidic environment, phenolic antioxidants can be very unstable and susceptible to both oxidation and hydrolysis, e.g., at neutral and alkaline pH. Without being limited to this mechanism, Applicant believes that this instability may begin with dissociation of the hydroxyl hydrogen in the phenol moiety of the antioxidant molecule. This dissociation, producing the negatively charged phenoxide ion, is favored at neutral to alkaline pH, and results in a chemically reactive molecule that is more susceptible to oxidation. It is interesting to note that aqueous phenol, a toxic laboratory reagent, is also susceptible to alkaline conditions, and is best stored under slightly acidic conditions as described by Perlman in U.S. Pat. No. 5,098,603.

Phenolic antioxidants include, but are not limited to, the monomeric single ring phenolic compounds, e.g., benzoic and cinnamic acid derivatives such as gallic and coumaric acids, and the polyphenolic compounds such as the two ring stilbene derivatives, e.g., resveratrol, the three ring compounds including the flavonoid derivatives such as the flavanols, flavonols, and anthocyanidins. While many of these compounds are present in fruits and vegetables, the catechins including epicatechin (EC), epicatechin gallate (ECG), epigallocatechin (EGC) and epigallocatechin gallate (EGCG) are well known flavonoids (flavan-3-ols) present in teas. The most abundant catechin in tea, EGCG, may constitute as much as 10% of the dry weight of fresh Camellia tea leaves. Accordingly, tea extracts as well as fruit-derived extracts, e.g., grape seed extracts, can be used herein to supplement processed food products.

Research in this area is interesting because it is thought that the methods described can have unexpected relevance to the present invention. For example, Ekanayake et al. in U.S. Pat. No. 5,427,806; No. 6,268,009; No. 6,063,428; and No. 5,879,733 describe the processing of green tea extract that initially contains high levels of unoxidized monomeric catechins, epicatechins, epigallocatechins and gallate derivatives. These phenolics are unfortunately easily oxidized to form diverse polymers and complexes with other soluble substances in the extract to produce an undesirable brown color, cloudiness, precipitates and altered taste. Dissolved metal ions, as catalysts, and oxygen in the tea extract aggravate this problem. Ekanayake et al. taught an improved tea extract prepared by extracting the tea with an aqueous acid such as ascorbic plus citric acid, removing the metal cations from the tea extract using a cation exchanger, and passing the extract through a nanofiltration membrane.

While in many cases it will be desirable to utilize plant extracts or plant preparations with substantial and varied phenolic antioxidant content as discussed above, in some cases it may be desirable to utilize single phenolic antioxidants or combinations (which may be artificially created) of different phenolic antioxidant compounds, or combinations in which one phenolic antioxidant compound is present in significantly higher concentration than in plant extracts which have not been enriched or purified for that compound.

Examples of compounds which can be utilized in this way include the substantially water soluble and fat insoluble compounds from among the following, some of which have been mentioned previously:

| | | |
|---|---|---|
| catechin | coutaric acid | sinapic acid |
| gallocatechin | fertaric acid | ferulic acid |
| epicatechin | p-coumaric acid | vanillic acid |
| epigallocatechin | m-coumaric acid | syringic acid |
| epigallocatechin gallate | o-coumaric acid | p-hydroxybenzoic |
| | | acid |
| catechin gallate | resveratrol (t-, c-, & mix) | protocatechuic acid |
| epicatechin gallate | myricetin | gentisic acid |
| gallocatechin gallate | myricetin glycosides | hydroxycaffeic acid |
| epicatechin digallate | quercetin | 3,4- |
| | | dimethoxycinnamic |
| | | acid |
| epigallocatechin digallate | quercetin glycosides | 3,4- |
| | | dihyroxybenzoic |
| | | acid |
| chlorogenic acid | delphinidin | 4-hydroxycinnamic |
| | | acid |
| gallic acid | delphinidin di-glucoside | 4- |
| | | hydroxycinnamoyl- |
| | | quinic acid |
| Caftaric acid | malvidin | piceatannol |
| Cichoric acid | malvidin di-glucoside | apigenin |
| caffeic acid | resveratrol glucoside | kaempferol |
| ellagic acid | peonidin | luteolin |
| petunidin | pelargonidin | carvacrol |
| scopoletin | apigenin | rhamnetin |
| eugenol | capsaicin | hesperidin |
| Isquercitrin | rutin | vicenin |
| rosmarinic acid | carnosic acid | hispidulin |
| Santin | eupafolin | scutellarein |
| genkwanin | acacetin | cirsimaritin |
| epirosmanol | rosmanol | rosmarinic acid |
| labiatic acid | isoetin | chrysoeriol |
| curcumin | eriodicyoyl | naringenin |

Thus, the invention includes the use of the above-listed compounds as single purified compounds, in combinations enriched in the particular compound, and in artificial combinations of the listed compounds. Such artificial combinations expressly include each and every combination of the listed compounds taken any 2, 3, 4, 5, 6, 7, 8, 9, 10, 11, or 12 at a time. The listing above includes aglycone forms, as well as glucoside and other glycoside forms and combinations of aglycone and glycosidic forms, whether or not each form is expressly shown in the list.

In some cases, compounds from certain advantageous categories are utilized, e.g., anthocyanidins, anthocyanins, procyanidins, proanthocyanidins, oligomeric proanthocyanidins, and/or oligomeric procyanidins are used.

Examples include homo- and hetero-dimers, trimers, tetramers, pentamers, hexamers, heptamers, and octamers of catechin (C), gallocatechin (GC), epicatechin (GC), epigallocatechin (EGC), epigallocatechin gallate (EGCG), catechin gallate (CG), epicatechin gallate (ECG), gallocatechin gallate (GCG). Examples of such heteropolymeric forms include ECG+C, ECG+EC, ECG+2C, ECG+2EC, 2EGCG+C, 2EGCG+EC, ECG+3C, ECG+3EC, ECG+4C, ECG+4EC, ECG+5C, ECG+5EC, ECG+6C, ECG+6EC, ECG+7C, and ECG+7EC, which may be used singly or in any combination.

Oxygen Considerations and the Stability of Phenolic Antioxidants in Oil Versus Aqueous Foods. Of the many edible fruit and vegetable sources of phenolic antioxidants, two current exemplary sources that are both concentrated and cost-effective for use in processed foods include: (a) a microparticulate purified grape seed extract that contains at least 90% by weight phenolic antioxidants (e.g., ActiVin®) and (b) microparticles of milled grape seed flour from cold-pressed viniferous grapes (containing insoluble fiber and water soluble phenolic antioxidants, usually up to approximately 10% water-soluble phenolic antioxidants). Applicant hypothesized that phenolic antioxidants contained in these microparticles might be degraded via oxidation more slowly in a fat environment rather than in water. However, one line of reasoning suggested that fat might accelerate rather than reduce the rate of oxidation of phenolics occurring in water.

More specifically, although phenolics tend to be insoluble in vegetable oil, the molecular oxygen component in air at room temperature and one atmosphere pressure is approximately five times more soluble in vegetable oils, e.g., soybean oil, than in water. This raised the possibility that fat/oil-borne oxygen might accelerate the decomposition of phenolic antioxidants particularly during heat processing of fatty foods. On the other hand, vegetable oil (e.g., soybean oil) has an intrinsic viscosity that is approximately fifty times greater than that of water at room temperature. This increased viscosity might reduce the amount of molecular oxygen reaching phenolic antioxidants suspended in oil versus water, and thereby reduce the reaction rate between oxygen and the phenolic compounds. Accordingly, microparticulate ActiVin® grape seed extract was used in a series of experiments (see below) in which Applicant measured and compared the levels of phenolic antioxidant surviving in a vegetable oil medium compared to several edible aqueous media.

Measuring Phenolic Antioxidant Stability in Edible Oil and Aqueous Environments. The chemical stability of phenolic antioxidants provided by a grape seed extract powder (ActiVin®) was measured in the following edible carrier substances: vegetable oils (corn oil and soybean oil) and various aqueous liquids (water, orange juice and vinegar). The ActiVin® utilized herein is a spray-dried powder with a particle diameter of approximately 50 microns. The powder contains approximately 90% by weight phenolics measured as gallic acid equivalents (GAE). Ten milligrams of the ActiVin® powder were placed in a series of 50 ml polypropylene clinical centrifuge tubes together with 20 grams individually, of each of the above edible substances. Each tube was shaken to mix the extract powder with the liquid. The powder was observed to fully dissolve in each of the aqueous liquids but did not dissolve in the corn oil or soybean oil. Each sample tube was prepared in duplicate, allowing one tube to be incubated in the refrigerator at 4° C. as a “control,” while the second tube was incubated at 60° C. to promote accelerated aging and oxidation.

The concentrations of residual phenolic antioxidant were measured in all samples after either 24 or 48 hours of incubation using the Folin-Ciocalteau reagent (see assay method below). For the insoluble ActiVin® samples (10 mg each) in corn oil and soybean oil, these samples were pelleted by centrifugation, dissolved in 0.1 ml ethanol, diluted with 20 grams water and similarly assayed. While the phenolic antioxidant activity decreased 20% for ActiVin® dissolved in water and 23% in orange juice after 48 hours incubation at 60° C. (compared to control samples maintained at 4° C., there was no measurable decrease for ActiVin® dissolved in vinegar after 48 hr incubation at 60° C. This is consistent with the general knowledge that mildly acidic conditions tend to stabilize phenolic antioxidants. For ActiVin® microparticles suspended in corn oil and soybean oil, no decrease in phenolic antioxidant activity was measured after either 24 hours or 48 hr of incubation at 60° C. when compared to controls maintained at 4° C. These results demonstrate that phenolic antioxidants contained in microparticulate grape seed extract can be combined with, and stabilized in edible oils. Thus, vegetable oils and processed fatty foods can function as excellent carriers in which dietary phenolic antioxidants are stabilized.

Phenolic Antioxidants in a Stabilizing Oil Environment Free of Water as an External Phase. According to this invention and the above experimental findings, fatty foods can be used as carriers for phenolic antioxidants in order to stabilize these antioxidants against premature hydrolysis and oxidation.

In many cases, these foods can advantageously contain at least about 10% by weight of a triglyceride-based fat. In some cases, the foods are also substantially free of water as an “external phase.” The concept of an external phase refers to water that is immediately available for chemical contact when an ingredient such as an antioxidant extract powder is added to the processed food composition. Such an external phase would dissolve the added antioxidant. Thus, it is possible to distinguish water contained in different water plus fat emulsions. If water is the internal phase (e.g., as the water microdroplets in a water-in-oil emulsion, for example, margarine spreads), then microparticles that contain antioxidant can remain oil-coated and the antioxidant need not dissolve in the internal water portion of the emulsion. Thus, antioxidants contained in water-in-oil emulsions qualify as compositions that are free of water as an “external phase” and are an important application for use of the present invention.

Notwithstanding these water-in-oil emulsions, the absence of any substantial amount of free water can also provide desirable compositions for application of this invention. Examples of substantially water-free fatty foods that are useful as antioxidant carriers in the present invention include peanut butter, salad oils, shortenings, including sweetened shortening fillings such as those used in cookie fillings and the like.

In addition, it has been found that the present invention can also be usefully applied to additional compositions, including compositions such as oil-in-water emulsions (e.g., liquid milks), in which water is the external phase.

Preferably, the phenolic antioxidants are coated and/or suspended within a fat or oil phase, and will remain substantially insoluble therein. By remaining insoluble in fat, Applicant believed that phenolic antioxidants would have a reduced tendency to become chemically reactive. More specifically, Applicant has added phenolic antioxidants to fatty foods including peanut butter and vegetable oil as either small solid microparticles of highly concentrated phenolic extracts or as microparticles of vegetable material containing lesser concentrations of phenolics.

Exemplary antioxidant sources include a spray-dried grape seed extract powder in the form of 50 micron particles known as ActiVin® (San Joaquin Valley Concentrates, Inc., Fresno, Calif.) which contains greater than 90% by weight phenolics, while a 140 mesh grape seed flour milled from cold-pressed viniferous grape seeds, and obtained from the same company contains approximately 10% by weight phenolics. Camellia sinensis tea leaf powders contain similar levels of antioxidants (approximately 10% by weight), except that the phenolics are present primarily as catechin compounds (see above). Concentrated water-soluble Camellia extracts are also available and have been obtained and can be used in the present invention. Of course, many other phenolic antioxidant preparations can also be used.

Phenolic Antioxidant Particles Remain Stable and Insoluble in Margarine. With a processed fatty food such as margarine that contains both an aqueous portion and a fat portion, it is possible to prevent or at least largely prevent the antioxidant from dissolving and prematurely oxidizing and/or hydrolyzing in the aqueous portion. In the case of margarine this is enhanced because the aqueous portion constitutes the internal phase and the semi-solid fat is the external phase. If the antioxidant is initially combined with fat, then the water portion is largely unavailable as a solvent to dissolve the antioxidant. To test this approach, 0.5 g and 1.0 g of viniferous grape seed flour (140 mesh flour granules) were vigorously mixed into a margarine (Smart Balance® Omega Buttery Spread, Smart Balance, Inc., Paramus, N.J.) that contains 70% by weight fat. The fat portion of the margarine emulsion was observed to wet the flour, and the water failed to dissolve any of the phenolic antioxidant within the flour granules. This was confirmed by the absence of any measured phenolic activity in the aqueous portion of the margarine.

In a second example, ActiVin® grape seed extract (spray-dried 50 micron diameter powder particles), that contain at least 90% water-soluble phenolic antioxidants were blended into the same margarine as described above. Remarkably, after vigorously blending 50 mg and 100 mg of this powder into 13 g portion servings of the margarine, little if any astringency could be tasted. After six hours of incubation at room temperature, phase microscopic examination of thin films of the margarine (150× and 600× magnification) confirmed the continuing presence and stability of the solid (undissolved) microspheres of the ActiVin® grape seed extract. By contrast, when the same amount of ActiVin® was pre-dissolved in a small amount of water and blended into the margarine, the astringent taste of the ActiVin® was immediately evident. Thus, margarine is an appropriate fatty food vehicle for maintaining phenolic antioxidants in a substantially insoluble and chemically stable state that exhibits minimal astringency when tasted.

Stabilization of Phenolic Antioxidants by Trapping in Low Mobility Matrix in Oil. As described above, fats and oils can be used to stabilize exogenously added phenolic antioxidants from premature oxidation. In the case of oil without a water phase being present, the oil acts as a stabilizing, non-dissolving environment. Substantially the same effect is present if a small amount of water is present in the form of widely dispersed water droplets within a principal oil phase. If a substantial aqueous phase is present, e.g., in a water-in-oil emulsion, enhanced trapping of phenolic antioxidants will occur when the oil phase is a semi-solid (e.g., in a margarine). In this environment the semi-solid oil acts as a low mobility matrix. Further, phenolic antioxidants can be protected from oxidation even when an aqueous phase is predominant, such as in an oil-in-water emulsion (i.e., with water as the external phase). This can be accomplished, for example, by trapping the antioxidants within a matrix, e.g., a fiber matrix. Examples of such trapping matrices include plant matter flour microparticles, e.g., from plant matter such as fruit seed flour microparticles, fruit skin flour microparticles, plant leaf flour, and combinations thereof (for example, grape seed flour, other fruit seed flours, and Camilla sinensis flour).

An example of such trapping within a predominantly aqueous environment has been performed in milk. Milk is particularly appropriate for this application because dissolving the phenolic antioxidants in the aqueous phase not only leads to greater oxidation of the phenolic antioxidants, but also leads to precipitation of milk proteins, especially when heated such as during heat pasteurization. Thus, for avoiding the chemical interaction between phenolic antioxidants and milk proteins, edible oil-saturated grape seed flour was utilized for introducing the phenolics into milks. This method uses the oil to mask phenolic antioxidants contained in the grape seed flour dramatically slowing diffusion of the antioxidants into the aqueous phase, and also prevent them from rapidly contacting and precipitating soluble proteins contained in the milk.

The target level selected corresponded to 1.0 g of 140 mesh (100 micron) grape seed flour from cold-pressed viniferous grapes (to provide 80-100 mg phenolic antioxidants) to be added to an 8 oz. serving of chocolate milk or regular milk. Based on preliminary experiments, it was found that approximately 0.75-0.80 g of edible oil (preferably ranging from 0.5 g to 1.0 g of oil) per 1.0 g of the flour should be added. For the oil, a high oleic, low linoleic acid sunflower oil was selected. This oil has also been used as a stabilization oil for dilution stabilization of omega-3 fish oil. Used at the ratio of 0.8 g oil per 1.0 g flour, the oil fully saturates the flour. The resulting suspension of grape seed flour in oil has a honey-like viscosity. When another 0.1 g or more of oil per 1.0 g flour is added, the flour suspension becomes quite fluid.

This flour-in-oil suspension can be homogenized and pasteurized into a milk, e.g., a chocolate milk or a regular non-fat, low fat, or whole milk. When added to regular milk with 1 g grape seed flour per serving, regular milk has a slightly off-white color. However, if a lighter colored plain milk is preferred, the grape seed flour level can be reduced, e.g., from 1 g down to about 0.6, 0.5, or 0.4 g per serving. There is no discernible taste or astringency contributed by the grape seed flour. This is consistent with the water-soluble phenolics being sequestered within the oil-protected flour granules. Also consistent with the water-soluble phenolics being sequestered is observed absence of precipitated milk proteins when the oil-protected flour is used. This indicates that the oil shields the phenolic antioxidants within the flour granules from reacting/precipitating with milk proteins.

Additionally, phase-contrast microscopy at 150× and 600× magnification was used to examine regular milk (1% milkfat) into which had been dispersed 1.0 g of the above-described grape seed flour that had been pre-saturated with 0.8 g sunflower oil (per 8 oz serving of milk). For dispersal, blended samples of this milk were vortex-blended with brief heating to approximately 90 degrees C. Under the microscope, the vast majority of flour particles were visibly oil-coated or embedded within slightly larger oil microdroplets, protecting the flour particles and the included phenolic antioxidants from the surrounding aqueous milk.

Depending on the efficacy of the homogenization process and the microparticle size, some settling of the oil-protected particles may occur. Shaking the milk prior to serving will redistribute the oil droplet/microparticles. For example, such settling may occur with microparticles of 140 mesh size. Such settling may be reduced or even effectively eliminated by using small particles, e.g., of about 200 mesh size or smaller. Such settling may occur to a greater extent in plain milk as opposed to higher viscosity milks such as chocolate milk. In such higher viscosity milks, the higher viscosity will reduce the rate of settling. Commonly components are added to chocolate milk to increase viscosity and reduce settling of cocoa particles. Those or similarly effective components may also be used in plain milk to reduce the rate of settling of the oil droplet/flour combination particles. Such components may include, for example, guar gum and/or carageenan.

More broadly, phenolic antioxidants can be protected by sequestering in low diffusion mobility solidified microparticles formed of material which is substantially insoluble in water but which are sufficiently dispersible in a mammalian (e.g., human) digestive tract to release entrapped phenolic antioxidants. For example, similar to the protection of phenolic antioxidants in margarine, phenolic antioxidants (e.g., as purified phenolic antioxidant preparations or as microparticles of phenolic antioxidant-containing plant matter flour) may be entrapped in microdroplets or microparticles of a fat which is solid or semi-solid at the relevant temperatures. The fat (or combination of fats) should be selected such that the fat microparticles will be sufficiently digested (e.g., emulsified and/or degraded) in the digestive tract to release a substantial fraction (preferably most or substantially all) of the entrapped phenolic antioxidants. Similarly, digestible waxes can be used for the same purpose. Such digestible waxes have been used, for example, for preparing some pharmaceutical compositions, e.g., in time-release capsules, coatings, binders, and other preparations, for example in Vaghefi & Savitzky, U.S. Pat. No. 6,849,271 which in incorporated herein by reference in its entirety for its description of such waxes. Combinations of fats and waxes can also be used in this invention.

Use of digestible solid materials such as the solid fats and/or waxes as microparticles to entrap and protect phenolic antioxidants allows application of the invention to a very broad range of food compositions. Thus, for example, phenolic antioxidants in wax microparticles may be added to an aqueous beverage or to an aqueous portion of another food, and the phenolic antioxidants will remain protected. In many cases, this protection will be effective even if the temperature of the food is raised above the melting point of the fat or wax (or other entrapping material), so long as that melting does not cause a large fraction of the phenolic antioxidants to be dissolved in an aqueous environment or reduces or delay such dissolution for sufficient time to provide effective protection. For example, if the fat or wax microparticles are incorporated in a food preparation which is then cooked, e.g., baked, in a manner which removes most of the free water, then the phenolic antioxidants can still be protected during the time when they would otherwise dissolve in the water present in the recipe and be subject to degradation. In addition, such solid edible material microparticles, e.g., solid fat or wax microparticles, can even be incorporated within another oil portions (e.g., a liquid oil portion) of a food composition. Thus, for example, wax microparticles containing phenolic antioxidants may be suspended in liquid oil and incorporated in a liquid milk. Many other such applications will also be apparent.

For use as a phenolic antioxidant entrapping material (e.g., solid fats and/or waxes) are highly preferably approved by the FDA or other similar food regulatory agency as an approved for direct food additive material, or other designation indicating approval for incorporation of the material in foods.

Of significant additional technical and bio-functional value, this use of fiber matrix microparticles (e.g., grape seed flour) embedded in oil (or other techniques of this invention in which phenolic antioxidants are embedded in oil) to protect phenolic antioxidants can be combined with a method for protecting omega-3 fatty acids in milk using dilution of the omega-3 fatty acids in stabilization oil. Such a stabilization oil is one which highly preferably is more stable to oxidation than the omega-3 fatty acid rich oil (that is, an omega-3 enriching oil). Thus, for example, 1 gram of high oleic sunflower oil that already contains an omega-3 enriching oil (e.g., fish oil or algae oil) can be blended with 1 gram of the grape seed flour. This blended grape seed flour in omega-3-containing sunflower oil can be homogenized/pasteurized into a chocolate milk or a regular milk, providing protection of phenolic antioxidants against premature oxidation, protection of milk proteins from precipitation by phenolic antioxidants (especially during pasteurization), and stabilization of omega-3 fatty acids.

Such stabilization of omega-3 fatty acids in milk and similar products applicable to the present invention is described in Perlman, U.S. patent application Ser. No. 12/143,729, filed Jun. 20, 2008 and/or Perlman U.S. patent application Ser. No. 12/276,447, filed Nov. 24, 2008, each of which is incorporated herein by reference in its entirety.

It is recognized that especially for foods in which the fat or oil is present in a fat in water emulsion or similar compositions, over time a significant amount of the phenolic antioxidants can extract or leach from the oil portion to the aqueous portion. However, in many cases the stabilization persists for sufficient time to be useful, e.g., for at least the intended shelf life of the food composition. In some cases, e.g., for liquid milks, the food product undergoes certain critical processing during which the phenolic antioxidants are at greater risk of degradation. For example, liquid milks are commonly subjected to heat pasteurization. The elevated temperature during such pasteurization causes rapid degradation of phenolic antioxidants present in the aqueous phase of the milk. In most cases, following pasteurization the milk is refrigerated to temperatures at which the degradation rate of phenolic antioxidants is very much reduced. In such cases, even if the phenolic antioxidants may migrate from the oil portion to the aqueous portion during refrigerated storage, the lower rate of degradation at such temperatures does not prevent the food from having a useful shelf life. Thus, the protection afforded during the much shorter critical processing is very useful.

Similarly, in cases where the oil portion is present as microdroplets in the aqueous portion (e.g., an oil in water emulsion such as a liquid milk), when purified phenolic antioxidant particles are used, the level of stabilization afforded by the oil may be less than desirable. In such cases, the level of stabilization can be significantly increased by using particles of stabilizing matrix. As described above, such a matrix may be a fiber matrix (e.g., a plant material flour) or another low diffusion matrix such as a solidified fat. This method for providing enhanced stabilization is applicable in many different types of food compositions, but is particularly useful in cases where the purified phenolic antioxidant particles are not stabilized to a desired level.

Fat as an Agent for Preventing Phenolic Antioxidant Astringency. As mentioned above in connection with incorporation of ActiVin® grape seed extract in the oil phase of margarine, the oil can shield the phenolic antioxidants such that less of the astringent taste normally associated with phenolic antioxidants is perceived upon ingestion.

Phenolic antioxidant compounds such as catechins and proanthocyanidins are well known for their astringency, particularly when present in foods and beverages at levels ranging from approximately 50-500 mg phenolics per serving (0.02%-0.5% by weight phenolics for 3 to 8 ounce serving sizes). The perception of astringency (also described as “mouth puckering”) depends upon the interaction between sensory receptors in the mouth and solubilized phenolic compounds. In the present invention, the solubilization of most phenolics is prevented or retarded by the presence of fat that bathes the microparticles carrying phenolic antioxidants. For example, when grape seed flour or grape seed extract particles are added to peanut butter or margarine and coated with fat before the food is tasted, the water-soluble phenolic antioxidants that would otherwise mix with saliva and taste as astringent, are partially masked by the fat. In the case of finely milled grape seed flour (e.g., 100-140 mesh size), the phenolic compounds are more sequestered within the flour particles and less prone to being tasted as astringent than with purified grape seed extract particles.

More specifically, approximately 90% by weight of the grape seed flour microparticle is non-phenolic material (fiber, protein, carbohydrates), that can substantially mask the taste of the 10% by weight phenolics. Furthermore, the phenolics are slow to diffuse from these oil-coated flour microparticles. On the other hand, the astringency from phenolics contained in microparticles of purified grape seed extract (e.g., ActiVin® microparticles typically containing 90% by weight or more of water-soluble phenolic antioxidants) is less well masked by combining with a fatty food such as peanut butter. This difference is attributable to the more rapid solubilization of phenolics contained in these extract microparticles compared to grape seed flour microparticles when mixed with saliva in the mouth. It is expected that the use of solid digestible solid material microparticles such as solid fat or wax microparticles will provide effective reduction of perceived astringency with both purified phenolic antioxidants and with plant material flour microparticles (or other fibrous microparticles) containing phenolic antioxidants.

Nevertheless, this method of using a fat or a fatty food as a carrier or vehicle for microparticles that contain substantial phenolic antioxidants, e.g., between 5% and 99% by weight phenolic antioxidants [percentage by weight phenolics measured as gallic acid equivalent (GAE) percentage], is an effective means of counteracting the astringency contributed by phenolic antioxidants added to fats and fatty foods. The mesh size of microparticles is preferably smaller than 80 mesh, e.g., 100 mesh (0.006 inch or 150 microns), and more preferably 140 mesh or smaller (0.004 inch or 100 microns) or even 200 mesh or smaller (0.003 inch or 75 microns). The ActiVin® microparticulate material obtained from San Joaquin Valley Concentrates, Inc. is approximately 50 microns in size.

In contrast, in co-pending U.S. Pat. Appl. Publ. 20080044539 entitled “Astringency-Compensated Polyphenolic Antioxidant-Containing Comestible Composition” Perlman et al. describe the use of an astringent amount of phenolic antioxidant dissolved in aqueous food and beverage compositions that also contain an effective concentration of at least one astringency compensating agent. While the present invention also employs phenolic antioxidants, these antioxidants are not dissolved in the comestible composition as in the invention described in the 20080044539 publication, but rather are maintained insoluble in the fatty portion of the food. Also, rather than using an astringency compensating agent of Perlman et al. to neutralize the taste of dissolved phenolics, the present invention circumvents the astringency problem by preventing the solubilization of phenolics, thereby also stabilizing the phenolics against premature oxidation.

### III. Stabilization of Omega-3 Fatty Acids in an Oxidative Stabilization Oil

As was described above, the use of an edible oil as a protectant for phenolic antioxidants can advantageously be combined with stabilization of omega-3 fatty acids by dilution in a stabilization oil, usually a high oleic, low linoleic oil vegetable oil. Such combination is discussed in greater detail below. In addition, such omega-3 fatty acid stabilization is described in Perlman, U.S. patent application Ser. No. 12/143,729, filed Jun. 20, 2008 and/or Perlman U.S. patent application Ser. No. 12/276,447, filed Nov. 24, 2008, each of which is incorporated herein by reference in its entirety for all purposes.

Oxidative Stability of Omega-3 and Other Polyunsaturated Fatty Acids is Not Compromised by Added Phenolics. In the above-described experiments, phenolic antioxidants were shown to remain essentially undissolved, and their antioxidant activities essentially constant in vegetable oils. As a result, fat-based foods such as salad oil, peanut butter, shortenings and margarine may provide advantageous storage and delivery vehicles for phenolic antioxidants. Furthermore, upon ingestion and contact with saliva and digestive juices, these phenolics will be solubilized and rendered bioavailable for absorption into the bloodstream. Beyond the consideration of phenolic antioxidant stability in these fatty foods, it also useful to consider the stability of certain polyunsaturated fatty acids, and in particular the bioactive omega-3 fatty acids, that are generally susceptible to oxidation during food processing and/or shelf storage. For example, if phenolic antioxidants react in any manner with omega-3 fatty acids, the oxidative stability of these fatty acids could be affected. As mentioned above, Perlman in U.S. Pat. No. 7,344,747 describes the oxidative stabilization of omega-3 fatty acids, including ALA found in flax seed oil, DHA found in algae oil and DHA+EPA fatty acids found in fish oil, by their dilution into a high oleic acid content peanut oil found in peanut butter produced from high oleic acid content peanuts. One of the objectives of the present invention is to obtain the biological benefits from increasing the dietary intake of both omega-3 fatty acids and phenolic antioxidants. These two nutrients are involved in different but complementary pathways that can modulate excessive inflammatory responses in the body. Therefore, one goal is to combine and simultaneously stabilize omega-3 fatty acids and phenolic antioxidants in fat-based processed foods such as peanut butter, margarine-type spreads, shortening and salad oil.

Oxidative Stability of Vegetable Oil is Maintained in the Presence of Phenolic Antioxidants. In experiments described above, phenolic antioxidants in grape seed extract were shown to remain stable and resist oxidation in vegetable oils. Applicant then proceeded with reciprocal tests in which the oxidative stability of vegetable oils carrying these phenolic antioxidants was examined. A peanut butter system was utilized that contained approximately 50% by weight endogenous peanut oil. To increase the sensitivity of the oil portion to oxidation, either of two different omega-3 fatty acid enriching oils was added to different peanut butter samples (ALA from flax seed oil, and DHA from algae oil). Phenolic antioxidants were added in the form of grape seed flour that contained approximately 10% by weight phenolic antioxidants (rather than the more concentrated grape seed extract). Using the same peanut butter oxidative testing protocol and analysis (NP Analytical Labs, St. Louis, Mo.) described in Example 3 of U.S. Pat. No. 7,344,747, a series of peanut butter samples (see below) were prepared for OSI (Oxidative Stability Index) testing. These measurements involve heating the peanut butter samples to accelerate the rate of oxidation of polyunsaturated fatty acids until induction of the oils occurs (rapid evolution of volatile decomposition products). These OSI tests were designed to show how stable or unstable the peanut oil becomes when supplemented with phenolic antioxidants (including omega-3 fatty acids at a “useful level”).

For the purposes of this invention, an amount of omega-3 fatty acids reaches this useful level if the amount of omega-3 fatty acid (provided by a triglyceride-based omega-3 enriching oil as defined herein) is at least 0.5 g of ALA per serving of food, or at least 20 mg of DHA or EPA or 20 mg of a combination of DHA+EPA per serving of food. With peanut butter, a serving size is 32 g and with margarine the serving size is 14 g. The term “triglyceride-based omega-3 enriching oil” as used herein refers to an edible fat or oil containing at least 20% and preferably greater than 30% by weight of omega-3 fatty acids. Thus, flax seed oil typically contains 40% by weight or more of ALA, fish oil typically contains in excess of 30% by weight DHA+EPA, and algae oil similarly contains in excess of 30% by weight DHA.

The OSI tested peanut butter samples were as follows:

1. Commercial “Smart Balance Omega Natural Peanut Butter” made from high oleic acid, low linoleic acid-type peanuts described in U.S. Pat. No. 7,344,747, with 1000 mg ALA from flax seed oil added per serving. The peanut oil in this product contains less than 10% by weight linoleic acid.
2. Same as #1 except also added 0.5 g grape seed flour per serving to provide approximately 50 mg per serving of phenolic antioxidants.
3. Same as #1 except in place of ALA, substituted 32 mg DHA per serving from algae oil.
4. Same as #3 except also added 0.5 g grape seed flour to provide approximately 50 mg per serving of phenolic antioxidants
5. Commercial Skippy Brand Natural Peanut Butter made from regular peanuts. The peanut oil in this product typically contains at least 30% by weight linoleic acid.

| Peanut Butter Sample | OSI (hours) |
|---|---|
| 1 | 47 |
| 2 | 47 |
| 3 | 122 |
| 4 | 118 |
| 5 | 28 |

Comparison of the OSI values for sample 2 vs. 1 and for sample 4 vs. 3 indicates that the addition of grape seed flour antioxidant to peanut butter fortified with omega-3 fatty acids (#2 with ALA) and (#4 with DHA) does not increase or decrease the oxidative stability index of the oil. These findings taken together with the results reported above indicate that phenolic antioxidants that are insoluble in an edible oil, and polyunsaturated fatty acids (including omega-3s), may be freely combined in fatty foods without affecting each other's oxidative stabilities.

Omega-3 Fatty Acid Incorporation If a relatively unstable omega-3-fatty acid-containing fish oil or algae is used herein, it can be dissolved in an “oxidative stabilization oil,” i.e., a carrier fat or oil such as an oxidation-resistant vegetable oil. The carrier oil is advantageously substantially more resistant to oxidation than the omega-3 fatty acid-containing oil. Preferably, the carrier oil (that acts as a chemical diluent for the omega-3 fatty acid enriching oil, e.g., fish oil) is an oil high in monounsaturated and/or saturated fatty acids and low in polyunsaturated fatty acids (e.g., preferably no more than about 20% polyunsaturated fatty acids). It is especially preferable that the carrier oil is low in linoleic acid. Particularly preferably as the carrier oil is a high-oleic, low-linoleic fat or vegetable oil. One example of such a carrier oil is high oleic/low linoleic acid sunflower oil (e.g., Clear Valley Sunflower Oil or Odyssey 100 Sunflower Oil sold by Cargill, Inc. (Minneapolis, Minn.) containing 10% saturated fatty acids, 82% by weight monounsaturated oleic acid and only 8% linoleic acid. Despite these preferences, a variety of different oils and oil blends may be used which have substantially greater oxidative stability as compared to omega-3 fatty acid-containing oils.

Therefore, to provide a 3-fold dilution, if 100 mg of DHA-containing algae oil is to be added as a supplement to a serving of peanut butter, it can be diluted with at least 200 mg of oxidative stabilization oil such as the low linoleic/high oleic-containing peanut oil that is naturally present in peanut butter manufactured using low linoleic acid, high oleic acid-containing peanuts. Much greater dilutions of the omega-3-enriching oil are more preferred with, for example, up to 50% by weight of the peanut butter being natural endogenous peanut oil (16 g per 32 g serving). This oil is available as the oxidative stabilization oil for 100 mg of algae to provide a 160-fold dilution rather than a 3-fold dilution of the DHA enriching oil.

Though the low linoleic/high oleic oil is preferred, other fats and/or oils may be used, e.g., cocoa butter, conventional palm oil, palm olein, palm superolein, and palm kernel oil (the palm oil and derivatives being low linoleic (e.g., about 9-11%)/high saturated fat oils), as well as conventional canola oil, soybean oil, cottonseed oil, corn oil, sunflower oil, milk fat, and/or safflower oil, as well as combinations of such oils.

In forming the blend of omega-3 enriching oil and omega-3 oxidative stabilization oil, in many cases, a single stabilization oil will be used. However, as indicated above, more than one oil may be used in combination as an oxidative stabilization oil. Such a combination will often be formed by mixing more than one oil to form the oxidative stabilization oil, before blending with the omega-3 enriching oil. However, the blend may also be formed by combining more than one oil, which together act as an oxidative stabilization oil, with the omega-3 enriching oil without premixing or with only partial premixing of the components of the oxidative stabilization oil. In many embodiments, the various oil components of the oxidative stabilization oil will each be oxidative stabilization oils, but alternatively, one or more of those component oils will not be oxidative stabilization oils alone, but the combination is an oxidative stabilization oil.

### Sacrificial Oil-Soluble Antioxidant in Oil Portion of Composition

As an approach to further enhance the oxidative stabilization of omega-3 fatty acid-containing oils by their dilution in an oxidative stabilization oil, or as an alternative to that approach, fat/oil soluble (water insoluble) antioxidants can be included in the compositions, e.g., in aqueous-fat emulsion type products such as margarines. In this approach, at least one oil-soluble antioxidant is blended with an omega-3 fatty acid-containing edible oil, or with an oxidative stabilization oil which is simultaneously or subsequently mixed with an omega-3 fatty acid-containing oil.

Using antioxidants to protect omega-3 fatty acids and other polyunsaturated fatty acids against oxidation in margarines and other fatty foods such as peanut butter and similar products, involves selection of appropriate antioxidants. The antioxidants should be fat/oil soluble, water insoluble antioxidants, or be antioxidants which can be used at sufficiently high concentrations and having sufficiently low solubility in water so that the residual antioxidant concentration in the oil portion is still sufficiently high so as to provide effective antioxidant protection. A number of antioxidant compounds are commonly used in foods. These include, for example, TBHQ, BHA, and BHT.

Tert-butylhydroquinone (TBHQ), also identified as 2-(1,1-Dimethylethyl)-1,4-benzenediol, is used as a food preservative, including as an antioxidant in edible oils. It is currently regarded as the most effective antioxidant for such oils and is stated to be effective in foods (e.g., fried foods) prepared using such oils. Nonetheless, TBHQ is less desirable for use as an antioxidant in water-containing products because it has appreciable water solubility. As a result, even if initially present in the oil phase of an emulsion, it will rapidly partition between the oil and aqueous phases. If a greater volume of the aqueous phase is present as compared to the oil phase in a composition, a substantial fraction of the TBHQ will partition into the aqueous phase and will not be effective to protect the omega-3 fatty acids (or other polyunsaturated fatty acids) from oxidation.

On the other hand, BHA (butylated hydroxyanisole) and BHT (butylated hydroxytoluene) have sufficiently sparing solubility in water that only a small amount of these compounds will partition from the oil phase to the water phase in a mixed composition. As a result, inclusion of one or both of these compounds in an oil preparation as indicated above, which is then mixed or homogenized with an aqueous phase, will provide effective oxidation protection.

Vitamin E (e.g., as D-alpha-tocopherol or D,L-alpha tocopherol) can also be added, and can serve as an antioxidant for oils. Vitamin E can also be added as a dietary supplement (most often in the form of D- or D,L-alpha-tocopheryl acetate), e.g., at levels of about 0.01 to 0.02% by weight of the composition. For use as an antioxidant, an active form (e.g., free tocopherol) is added to the oil, in many cases at a level of about 100 to 5000 ppm or more commonly about 200 to 2000 ppm in the oil, e.g., about 200 to 500, 300 to 700, 500 to 1000, 700 to 1500, or 1000 to 2000 ppm. Other isomers of tocopherol can also be used as alternatives or in addition, such as beta-tocopherol, gamma-tocopherol, delta-tocopherol, and combinations thereof.

A number of additional compounds can also be used for similar purposes. These include, for example, carotenoids such as lycopene, lutein, gamma-carotene, astaxanthin, canthaxanthin, alpha-carotene, bixin, zeaxanthin, cryptoxanthin, and crocin, as well as fat-soluble vitamins in addition to Vitamin E as mentioned above, such as Vitamin A (or the related beta-carotene), Vitamin D, and Vitamin K.

Such fat-soluble antioxidants can be used singly or in combination in an edible oil. As indicated, this use can further protect polyunsaturated fatty acids from oxidation, particularly including omega-3 fatty acids. At the same time, the dilution of the fat-soluble antioxidants in the stabilization oil can protect those antioxidants from reaction because the dilution reduces the reaction kinetic by reducing the second order propagation of free radicals among molecules undergoing peroxidation.

### DEFINITIONS

To assist the understanding of the reader, and for the purposes of the present invention and the claims, the following terms are applicable and have the indicated meanings:

In the context of this invention, the terms “fats” and “oils” refer to edible fats and oils, and are used equivalently except as clearly indicated to the contrary. Thus, in some cases a liquid fat or oil may be indicated, while in others a solid fat or oil may be indicated. Reference to a “solid fat” or “solid oil” means that the fat or oil is solid or semi-solid at a context-relevant temperature, often at room temperature or at normal storage temperature.

The two terms, “phenolic antioxidants” and “polyphenolic antioxidants,” and the measured concentrations thereof, refer to the collective population of molecular species made by plants (and ingested by animals) containing one or more aromatic ring structures having at least one hydroxyl, substituent. For the purposes of this invention, these two terms are used interchangeably unless a distinction is made clear.

In the context of additions of phenolic antioxidants to edible oils or other edible oil-containing food compositions, the terms “exogenous”, “exogenously added” and like terms means that the phenolic antioxidants are added to a food composition by people, as distinguished from phenolic antioxidants that are naturally present. Thus, for example, phenolic antioxidants in the form of grape seed flour and/or grape seed extract which are added to an oil (which could be a grape seed oil) or another food composition are “exogenous” or “exogenously added” phenolic antioxidants, while phenolic antioxidants which are found in olive oil or grape seed oil obtained by cold pressing are “endogenous” phenolic antioxidants and are not “exogenously added.”

For the purposes herein, the concentration or “percentage by weight” of phenolic or polyphenolic antioxidant is assayed and expressed as an equivalency to a percentage by weight of gallic acid; i.e., gallic acid equivalents or GAE units that are units of concentration. These so-called phenolic or polyphenolic concentrations are measured using a colorimetric assay based upon reacting phenolic/polyphenolic compounds with Folin-Ciocalteau reagent (abbreviated “F-C reagent”). This assay of phenolic chemical groups does not distinguish between simple phenolic derivative compounds and more complex polyphenolic structures. For the purposes herein, phenolic antioxidants represent all of the phenolic group molecular species (molecular structures) that remain soluble in an aqueous liquid such as a beverage or water-containing food such as a soup, condiment, aqueous emulsion, bakery product and the like. Phenolic and polyphenolic antioxidants can include some molecules that have already undergone a limited amount of oxidation and/or polymerization due to exposure to air, light.

In the Folin-Ciocalteau assay, a gallic acid standard solution (1.00 mg/ml) is used to generate a linear standard curve. Increasing amounts of the gallic acid solution (between 2.5 and 15 microliters) are diluted into a series of sample test tubes holding 0.50 ml water. Next, 50 microliters of F-C reagent (Sigma Chemical Company) is added to each tube. After 1 minute, but before 8 minutes following addition of the F-C reagent, 0.25 ml of a 15% by weight aqueous sodium carbonate solution is added, the samples are vortexed, and then incubated (maintained) for 2 hours at room temperature. The optical absorbance at 760 nm is read. A sample that is constituted with all chemical components but without gallic acid is also incubated as used as a blank sample to zero the sprectrophotometer (Spectronic 20D+manufactured by Thermoelectron Corp.). This blank registered an absorbance (optical density or O.D.) at 760 nm of approximately 0.005 above that of distilled water. In the assay, an O.D. 760 nm reading of 1.3-1.4 corresponded to approximately 10 microliters of 1.00 mg/ml gallic acid. Also, for reference purposes, a commercial single strength Concord 100% grape juice (Welch's) was shown to have the equivalency in the F-C assay of approximately 0.25% gallic acid (0.25 GAE units).

As antioxidants, the phenolics can scavenge unpaired electrons (free radicals), inactivate reactive oxygen species, and chelate metal ions that catalyze oxidation. A partial list of prevalent phenolic species include the simple cinnamic and benzoic acid derivatives, the stilbenes (2 phenolic rings), the 3 ring flavonoids (2 phenolic rings plus a flavone ring) that include catechins, flavanols, the anthocyanidins (not glycosylated) and the positively charged anthocyanins of many different structures (glycosylated anthocyanidins having colors ranging from red to blue), and the four ring ellagic acid species and its derivatives as well as a variety of tannins, to name a few.

The term “fat portion” is used to refer to the fat or oil fraction within a present food composition, fat component, or fat composition. Thus, the fat portion is a triglyceride-based fat or oil composition (which may be liquid or solid or have both liquid and solid portions, and/or which may be a component of a more complex food composition) that serves as the immediate vehicle for carrying phenolic antioxidant(s), in which these phenolic antioxidants typically remain substantially undissolved and chemically more stable than when dissolved in traditional aqueous foods and beverages, which are considered essentially “non-protective”).

In the context of the present food compositions, the term “fat component” (or equivalently “oil component”) refers to a component of the food composition which contains a substantial amount of fat, where that fat contains at least one exogenously added phenolic antioxidant. Such fat component may also include other materials, e.g., aqueous microdroplets. The term “antioxidant-protective fat component” (or equivalently “antioxidant-protective oil component”) both abbreviated as “AP fat component”) refers to a fat component which protects phenolic antioxidants within the fat portion of the fat component (which may be in a prepared food) from degradation as compared to the degradation of the same phenolic antioxidants in water at pH 7, where the protection is provided by reducing the rate at which the phenolic antioxidants are exposed to water and/or oxidative environment. Such AP fat component may, for example, be a fat portion with the absence of an aqueous environment (e.g., as a cooking or salad oil or in a peanut butter or other nut butter), may have included water (e.g., a water-in-oil emulsion with liquid oil, a water-in-oil emulsion with solidified or semi-solidified oil, a water-in-oil suspension or emulsion with the phenolic antioxidants in a low mobility matrix (e.g., fiber matrix microparticles)), or may be in an environment with aqueous medium adjacent to the antioxidant-protective oil (e.g., an oil-in-water emulsion or suspension with the phenolic antioxidants in a low mobility matrix (for example, in a low mobility matrix such as solidified or semi-solidified fat and/or fiber matrix microparticles)). An “antioxidant-protective fat or oil composition” is the same as an “antioxidant-protective fat component” except that it refers to the material separate from other food components.

Highly advantageous “antioxidant-protective oil components” and “antioxidant-protective oil compositions” are “diffusion-inhibiting oil compositions”, which refers to fat and oil compositions that have a physical form (e.g., sufficient degree of viscosity, or semi-solid versus liquid state), and/or dimensions (sufficient average diffusion distance and time of travel by phenolic antioxidant particle through fat or oil), and/or contains one or more agents (e.g., hardstock fats, fibrous particles, or other substances that can capture and/or significantly retard migration of the phenolic antioxidants) that significantly reduce the normal rate of diffusion or migration of phenolic antioxidants in their free molecular and physical state at temperatures relevant to the production or storage of food compositions incorporating such diffusion-inhibiting oil compositions as compared to the migration rate of the same phenolic antioxidants from liquid oil droplets in an oil-in-water emulsion into the external water phase of the emulsion. Such physical form of the fat or oil can include, for example, having aqueous droplets widely separated in a water-in-oil emulsion or similar suspension, and/or a solidified fat or oil phase. Examples of inclusion or capturing-type materials which can effectively reduce the rate of diffusion of phenolic antioxidant from oil to water can include, for example, those materials at an oil-water interface which can inhibit transfer of phenolic antioxidants from the oil to the water, and/or having a matrix (e.g., fiber particles such as grape seed flour particles) which traps phenolic antioxidants within the matrix.

The term “comminuted” or “milled” as relating to grape seeds and other fruit and vegetable material refers to physical processing and reduction of particle size by mechanically crushing, grinding and/or milling that can be used to convert the particles into flours of varying mesh size. Broken grape seeds are typically reduced from 20 mesh to finer particle sizes of 40 mesh, 60, 80, 100 and even 140 mesh size or smaller. Prior to comminution, grape seeds are cleaned, e.g., with water, and usually dried. Drying is required for subsequent processing (such as pressing for oil and/or grinding into flour). The drying process reduces the moisture level in the grape seeds, preferably to 10% by weight or less. Drying is important for preventing growth of molds and other microbes, as well as for mechanical processing. Although comminuted grape seeds may be prepared from “native grape seeds” defined as grape seeds that contain their natural native level of endogenous grape seed oil (usually about 10% by weight), milled grape seed flours are usually prepared from grape seeds that have been cold-pressed or otherwise treated to reduce some or even most of their oil content. Defatting may be accomplished by either mechanical or chemical means. Mechanical means (e.g., pressing of the seed) is preferred over chemical means involving treatment with an organic solvent to extract the endogenous oil. Pressing of grape seeds typically reduces grape seed oil content from its native level of approximately 7-12% by weight to 1-2% by weight. Besides yielding commercially valuable grape seed oil, the defatting process provides grape seed material that has a longer shelf life because it is less susceptible to oxidative rancidity. A non-exclusive list of grape species that can used as a source of grape seed flours and antioxidant extracts from their seeds, skins, and/or pulp includes Vitis labrusca (Concord), Vitis rotundifolia (Muscadine), Vitis vinifera (European wine grape) and combinations of these.

The term “grape seed extract” such as the commercially available ActiVin® product (San Joaquin Valley Concentrates, Fresno, Calif.) is described elsewhere herein. A non-exclusive list of grape species that can used to make the grape juice as well as the complementary phenolic antioxidant extracts from skins, seeds and/or pulp includes Vitis labrusca (Concord), Vitis rotundifolia (Muscadine), Vitis vinifera (European wine grape) and combinations of these.

The term “astringency” as used herein is the taste sensation or mouth feel that is most apparent as an aftertaste, and is often described as mouth puckering. Astringency is often associated with the tannin content of immature wines, i.e., wines that are not sufficiently aged. The sensation of astringency is thought to be caused by a reaction between phenolic compounds such as the tannins and the so-called PRP proteins (proline-rich proteins) in saliva that are thought to provide wetting, lubrication and protection of the oral epithelium. Research suggests that the precipitation and/or aggregation of complexes formed between the salivary proteins and phenols results in loss of oral lubricity-thus the tightened, dry, rough or “puckery” sensation on oral surfaces such as along the sides of the taster's tongue.

The term “sacrificial antioxidant” refers to a chemical substance that is added to a processed food composition for the purpose of protecting an ingredient that is susceptible to oxidation. By being more susceptible to oxidation than the ingredient being protected, the sacrificial antioxidant is consumed first before an appreciable amount of the valuable ingredient is lost. Examples of these sacrificial antioxidants include vitamin C, rosemary extract, TBHQ, BHA, BHT, propyl gallate and combinations and derivatives thereof that are edible food additives and GRAS (see above) at the levels prescribed by governmental regulations.

The term “shelf life” or “shelf-stable” in the context of phenolic antioxidants contained in a processed food product refers to a loss of less than 25% per year in the phenolic antioxidant content of the material when stored at 20° C.

The term “pasteurized” refers to a method of treating edible materials, generally by heating them (alternatively in some instances by gamma irradiating) to a certain point to kill pathogenic microorganisms but not harm the flavor or quality of the food. Milk is pasteurized by heating it to about 145° F. (63° C.) for 30 minutes or, using the “flash” method, by heating it to 160° F. (71° C.) for 15 seconds, followed by rapid cooling to below 50° F. (10° C.), at which temperature it is stored. Pasteurization is also used with other beverages and food products. Very stringent flash pasteurization can expose a beverage to a temperature as high as 185° F. for as long as 30-60 seconds. Surprisingly, it has been found that illustrative phenolic antioxidant-enhanced processed food products can be pasteurized without losing more than 5% to 10% of their phenolic content measured prior to pasteurization.

The term “food composition” within the context of the present invention refers to any edible solid, liquid or gel composition suitable for human consumption. A “processed food composition” refers to food composition which has been modified from a naturally occurring edible material, e.g., by cooking, combining of ingredients, and/or changing the levels of components within a food composition.

The term “omega-3 fatty acid-containing enriching oil” or “EPA/DHA (fatty acid) enriching oil” or “DHA enriching oil” or “ALA (fatty acid) enriching oil” refers to any edible triglyceride-based oil composition that contains an abundance of one or more of the omega-3 fatty acids, EPA, DHA and/or ALA along with other fatty acids. A typical omega-3 enriching oil may contain approximately 30% or more by weight of EPA and/or DHA or ALA. Further distinguishing the present omega-3 fatty acid-containing enriching oils from conventional cooking and salad oils is that a substantial proportion of the triglyceride molecules in the enriching oils contain two, and sometimes three, omega-3 fatty acids esterified within the same triglyceride molecule. Thus, for the three glycerol carbon positions within omega-3-containing triglyceride molecules found in the enriching oils, often the sn-1 and sn-2, or the sn-2 and sn-3, or the sn-1 and sn-3 positions are esterified with omega-3 fatty acids. The term “abundance” as used herein means that the enriching oil contains a total of at least 10% by weight of omega-3 fatty acids including EPA and/or DHA fatty acids, and/or ALA, and preferably 20-35% or even 35-60%, or higher EPA and/or DHA and/or ALA fatty acids.

Similarly, the terms “omega-3 enriching oil” and “omega-3 fatty acid-containing enriching oil” and like terms refer to an edible oil that is either or both of an “EPA/DHA fatty acid-containing enriching oil” or a “DHA fatty acid-containing enriching oil” or an “alpha-linolenic fatty acid-containing enriching oil”.

Oxidation rate in a fat-containing food composition is determined by an OSI measurement. A significant reduction in oxidation rate is a statistically significant reduction, preferably such that the rate of oxidation in the oil portion is not more than 0.80, 0.70, 0.50, 0.30, 0.20, 0.10, 0.05, 0.02, 0.01, or 0.005 of the rate in the control oil. In many advantageous cases, the oil portion of the food composition is a blended oil composition, i.e., a mixture of edible oils, that includes:

(a) an omega-3 fatty acid-containing enriching oil ((providing EPA and/or DHA and/or ALA, see above) that is susceptible to oxidation and, that is combined and diluted with

(b) a triglyceride-based edible oil that possesses good oxidative stability compared to the oxidative stability of oils high in omega-3 fatty acids. Preferably such oil is low in polyunsaturated fatty acids (especially linoleic acid) and high in monounsaturated (e.g., oleic) and/or saturated fatty acids. Preferred examples of the edible oil having good oxidative stability can be referred to as “oxidative stabilization oils”, such as low linoleic/high oleic sunflower oil.

The term “fish oil” refers to an edible oil refined from the tissues of many varieties of oily fish such as mackerel, sardines and herring. Fish oil commonly contains between 20% and 30% by weight of a combination of EPA and DHA long chain polyunsaturated fatty acids. The fish do not actually produce omega-3 fatty acids, but instead accumulate them by consuming microalgae (also termed “algae” herein) that produce these fatty acids or other organisms which have accumulated those fatty acids. Marine microalgae, or phytoplankton, provide the food base for the entire sea animal population. The best known microalgae are the diatoms, dinoflagellates, green algae and blue-green algae. These microalgae species produce a wide range of lipid fatty acids including significant quantities of the essential polyunsaturated fatty acids, linoleic acid, alpha-linolenic acid (ALA) and the highly polyunsaturated omega-3 fatty acids, octadecatetraenoic acid (C18:4), eicosapentaenoic acid (EPA, C20:5) and docosahexaenoic acid (DHA, C22:6).

Thus, the term “algae oil” refers to an omega-3 enriching oil obtained from lipid-producing microorganisms, including for example, diatoms, dinoflagellates, green algae, and/or blue-green algae. Certain varieties can produce oils containing a high level of the omega-3 fatty acid, DHA, e.g., 20% to 40% or more by weight of DHA.

The term “rate of oxidation” in the context of oxidative loss of phenolic antioxidants within a fat-containing food composition described herein, refers to the rate of accumulation of by-products from phenolic antioxidant oxidation including acids and ketones, for example. The loss of phenolic antioxidants may be measured by a variety of methods known to those skilled in the art, including, for example, colorimetric analytical methods using the Folin-Ciocalteau reagent that reacts with phenolic compounds.

In connection with the use of phenolic antioxidants in the present invention, the term “water soluble and fat insoluble” means that the particular phenolic antioxidant compound or combination of compounds or molecular species have a water/average canola-type vegetable oil partition coefficient at 4 degrees C. of at least 20, but preferably at least 25, 50, 100, 200, 300, 500, 700, or 1000, or even greater. In this context, the partition coefficient is the ratio of the concentration of the solute in water to the concentration of the solute in the vegetable oil at equilibrium (C_{w}/Cₒ).

In the context of microparticles of fats, waxes, and other entrapping materials for phenolic antioxidants, the term “digestible” is used to mean that the material is edible and is at least partially dispersible from microparticles in the human digestive tract (e.g., by bile). It does not require that the material is metabolizable to any significant degree, although such metabolization is not excluded.

In reference to a particular type of vegetable oil, the term “average” means that the components (primarily the particular fatty acids) of the oil have median values based on a large number of independent geographically and temporally diverse samples of the specified oil.

As used herein in connection with particle sizes, the term “mesh size” refers to mesh sizes in the U.S. Standard Sieve Series.

In the context of this invention, the term “plant matter flour” refers to a finely milled powder made from one or more plant products, e.g., seeds (often de-fatted) such as grape seed and berry seeds (e.g., raspberry seeds) and/or leaves such as tea leaves of Camilla sinensis.

All patents and other references cited in the specification are indicative of the level of skill of those skilled in the art to which the invention pertains, and are incorporated by reference in their entireties, including any tables and figures, to the same extent as if each reference had been incorporated by reference in its entirety individually.

One skilled in the art would readily appreciate that the present invention is well adapted to obtain the ends and advantages mentioned, as well as those inherent therein. The methods, variances, and compositions described herein as presently representative of preferred embodiments are exemplary and are not intended as limitations on the scope of the invention. Changes therein and other uses will occur to those skilled in the art, which are encompassed within the spirit of the invention, are defined by the scope of the claims.

It will be readily apparent to one skilled in the art that varying substitutions and modifications may be made to the invention disclosed herein without departing from the scope and spirit of the invention. For example, variations can be made in the particular choice of triglyceride-based fat or oil in the claimed composition, source and selection of vegetable or fruit-derived phenolic antioxidant compound(s), choice of microparticulate material containing such antioxidant compounds, source of omega-3 fatty acid-containing enriching oils, method of combining and/or diluting ingredients in the claimed composition and the like. Thus, such additional embodiments are within the scope of the present invention and the following claims.

The invention illustratively described herein suitably may be practiced in the absence of any element or elements, limitation or limitations which is not specifically disclosed herein. Thus, for example, in each instance herein any of the terms “comprising”, “consisting essentially of” and “consisting of” may be replaced with either of the other two terms. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

In addition, where features or aspects of the invention are described in terms of Markush groups or other grouping of alternatives, those skilled in the art will recognize that the invention is also thereby described in terms of any individual member or subgroup of members of the Markush group or other group.

Also, unless indicated to the contrary, where various numerical values or value range endpoints are provided for embodiments, additional embodiments are described by taking any 2 different values as the endpoints of a range or by taking two different range endpoints from specified ranges as the endpoints of an additional range. Such ranges are also within the scope of the described invention. Further, specification of a numerical range including values greater than one includes specific description of each integer value within that range.

Thus, additional embodiments are within the scope of the invention and within the following claims.

1. A fat-containing processed food composition suitable for human consumption, comprising:
an antioxidant-protective component (AP fat component) comprising at least one triglyceride-based fat or oil, wherein said fat component comprises a fat portion and optionally an aqueous portion; and
at least one chemical species of exogenously added water-soluble phenolic antioxidant that is dispersed yet substantially undissolved within the fat portion of said food composition, wherein the oxidative stability of said phenolic antioxidant in said fat portion is greater than when dissolved in an equal portion of water at pH 7.

2-38. (canceled)

39. A method of producing a shelf-stable processed food product containing at least one chemical species of plant matter-derived phenolic antioxidant, comprising:
incorporating at least one exogenously added chemical species of plant matter-derived phenolic antioxidant in a fat portion of an antioxidant-protective fat composition (AP fat composition); and
incorporating said fat composition in said food product,
whereby said plant matter-derived phenolic antioxidant is stabilized against oxidation by its incorporation into said fat portion.

40. A method of stabilizing water soluble plant matter-derived phenolic antioxidants against oxidation comprising:
suspending non-colloidal microparticles of said phenolic antioxidants within the fat portion of an antioxidant-protective fat composition (AP fat composition).
